(19) United States
(12) Patent Application Publication
(10) Pub. No.: US 2004/0002791 A1
(43) Pub. Date: Jan. 1, 2004

(54) Fuel cell monitoring system

(76) Inventor: Ki-Chun Lee, Kyungki-Do (KR)

Correspondence Address: Pennie & Edmonds, LLP, 3300 Hillview Avenue, Palo Alto, CA, 94304, US

(21) Appl. No.: 10/185,381

(22) Filed: Jun. 27, 2002

(51) Int. Cl. G05F 5/00; H01M 8/04

(52) U.S. Cl. 700/286; 429/23

(57) ABSTRACT

A fuel cell monitoring system whereby the voltages of each unit cell in a fuel cell are compared with a reference voltage without converting the voltages of the unit cell from analogue to digital, and whether or not each unit cell is working normally is set as O or 1, thereby greatly reducing the amount of information to be processed and simplifying a monitoring circuit.

### FIELD OF THE INVENTION

The present invention relates to a fuel cell monitoring system, and more particularly to a fuel cell monitoring system adapted to monitor the status of a fuel cell based on the voltage data of a unit cell comprising the fuel cell.

### DESCRIPTION OF THE PRIOR ART

Generally, the operation of voltage of a unit cell in a fuel cell or a secondary cell is very low, such that scores of unit cells or as many as hundreds of unit cells must be connected in series in order to be used as a power source of a vehicle. A unit body (hereinafter referred to as cell body) composed of several unit cells connected in a series is called a stack in the case of a fuel cell and a module or a pack in the case of a secondary cell.

The operational state in a cell body fluctuates according to deviations in the manufacturing process of unit cells, and distribution of temperature and pressure in the cell body. If abnormal operation of a unit cell occurs in even one unit cell of a cell body, the whole cell body where a plurality of unit cells are connected in a series may not operate normally. As a result, a monitoring system is needed for determining whether or not cells are operating normally by monitoring the voltages, temperatures and the like for cell units wrapped in a unit or in bundles each comprised of several unit cells when the cell units are in operation.

The voltage of a unit cell is one of the most important monitoring elements for determining whether or not each unit cell is working properly. In this connection, a monitoring system coverts an analogue-type voltage signal of each unit cell to a digital type voltage signal, which is in turn compared with a previously-input normal state of value to determine whether a normal operation is being performed.

FIG. 1 is a block diagram illustrating a fuel cell monitoring system according to the prior art. In the monitoring system 1 shown in FIG. 1, each analogue voltage signal output from each unit cell (10-1˜10-N) comprising a fuel cell 2 is converted to a digital signal by Analogue/Digital(A/D) Converters (20-1˜20-N) equal to the number of unit cells or monitoring objects to be input to a computing system 40. The computing system 40 processes the digital signal in response to a previously-input program to check whether or not each unit cell is working normally.

The voltage of each unit cell (10-1˜10-N) changes constantly such that it is preferable to simultaneously process as much as possible, where data process speed is determined by factors such as the amount of data to be processed, accuracy, sampling period, system construction method, and whether the entire voltage of the unit cells can be simultaneously processed is also determined.

Particularly, with respect to the secondary cell, it must be charged and recharged repeatedly and the conduction of the cell under each circumstance of charge and discharge must be accurately monitored, in response to which corresponding actions must be taken accordingly. However, these actions directly relate to the life of an entire cell body, whereby the structure of the monitoring system and data process method are rather complicated and volume thereof is enormous.

In order to secure simultaneity of signal processing, as many unit cells (10-1˜10-N) as the A/D converters (20-1˜20-N) are attached, as illustrated in FIG. 1, to simultaneously convert the voltages of the entire unit cells (10-1˜10-N) in response to a data sampling period. However, there are problems in this case in that scores or hundreds of A/D converters (20-1˜20-N) are mobilized to thereby increase the price and size of the monitoring system 1.

As shown in FIG. 2, in order to reduce the number of A/D converters 20, a relay 30 may be used whereby one converter 20 processes signals of a plurality of unit cells (10-1˜10-N). However there is a problem in that although the price and size of the monitoring system 1 may be reduced, information cannot be simultaneously processed.

Information of each unit cell (10-1˜10-N) converted to a digital signal is transmitted to the computing system 40 to be processed by the previously input program, whereby the status of each unit cell (10-1˜10-N) within the cell body 2 is checked. However, there is another problem in that the voltage of each unit cell (10-1˜10-N) is treated as a numerical value to increase the amount of information to be processed.

There is still another problem in that, when the amount of information to be processed is increased, the processing speed of the computing system 40 and communication speed in each component must be quickened and more memory is need to store information, resulting in the increase of cost in the monitoring system.

### SUMMARY OF THE INVENTION

The present invention provides a fuel cell monitoring system adapted to significantly reduce the amount of information to be processed and to simplify its structure, thereby reducing the cost and size thereof.

In accordance with an embodiment of the present invention, a fuel cell monitoring system checks the status of each of a plurality of unit cells each connected in a series in a fuel cell based on the voltage of the unit cell. Preferably, the system comprises a differential amplifier for outputting the voltages of the unit cells, a comparator for comparing the voltages of the unit cells output from the differential amplifier with a reference voltage to output a digital signal of “0” or “1”, and a computing system for receiving the digital signal of “0” or “1” to process in response to a previously-input program and to check whether each unit cell is working properly.

In another preferred alternative embodiment, a fuel cell monitoring system comprises at least one differential amplifier and at least one comparator. The at least one differential amplifier communicates with at least one unit cell of the fuel cell to generate an output voltage corresponding to the unit cell. The at least one comparator communicates with the at least one differential amplifier. The comparator compares the output voltage to a reference voltage and generates a digital signal based on the comparison. The digital signal, preferably a 1 or 0, is adapted for monitoring the fuel cell, preferably by a processor. The system may further include a reference voltage generator communicating with the comparator, with the comparator outputting a 1 or 0 dependent upon the comparison. Alternatively, the reference voltage comprises an average voltage computed by dividing a total cell system voltage by the number of unit cells. In this alternative, the comparator also outputs a 1 or 0, one of those signals being output if the unit cell voltage is below the reference voltage and the opposite of those signals being output if the unit cell voltage is above the reference voltage. Preferably, the fuel cell includes a plurality of unit cells and the monitoring system comprises one differential amplifier and one comparator corresponding to each unit cell.

In a further preferred embodiment the fuel cell comprises a plurality of unit cells and the monitoring system comprises a plurality of differential amplifiers and a plurality of comparators. One of the plurality of differential amplifiers corresponds to each unit cell and is connected to both ends of the unit cell to generate an output voltage of the corresponding unit cell. Also included in the system is means for generating a reference voltage. Each of the plurality of comparators, one corresponding to each differential amplifier, compares the output voltage to the reference voltage and generates a digital signal based on the comparison. The digital signal is adapted for monitoring the fuel cell the status. In one alternative, the means for generating a reference voltage comprises a voltage generator and the comparator outputs a ditigal 1 or 0 dependent upon the comparison. In another alternative, the means for generating a reference voltage comprises a processor programmed to compute an average voltage of the plurality of unit cells. In this alternative the comparator also outputs a digital 1 or 0. One of the signals is output if the unit cell voltage is below the reference voltage and the opposite signal is output if the unit cell voltage is above the reference voltage.

### BRIEF DESCRIPTION OF THE DRAWINGS

For fuller understanding of the nature and objects of the invention, reference should be made to the following detailed description taken in conjunction with the accompanying drawings in which:

FIG. 1 is a block diagram of a fuel monitoring system according to the prior art;

FIG. 2 is a block diagram of a fuel cell monitoring system according to another embodiment of the prior art;

FIG. 3 is a graph illustrating operational parameters of a fuel cell; and

FIG. 4 is a block diagram of a fuel cell monitoring system according to the present invention.

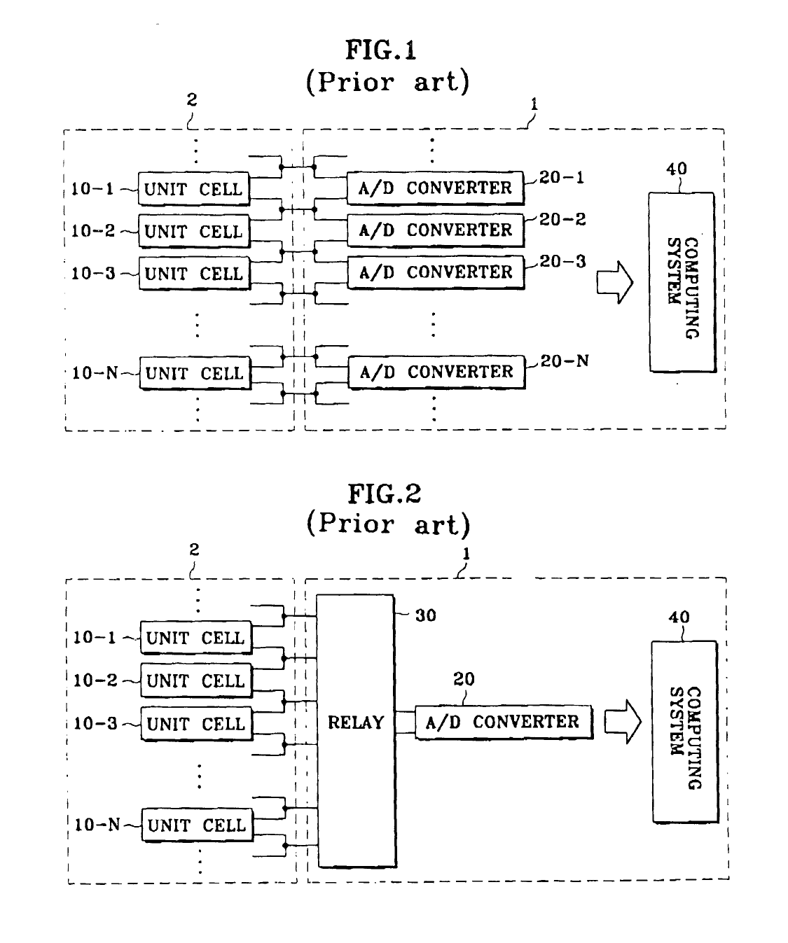

### DETAILED DESCRIPTION OF THE INVENTION

Now, the embodiment of the present invention will be described in detail with reference to the accompanying drawings.

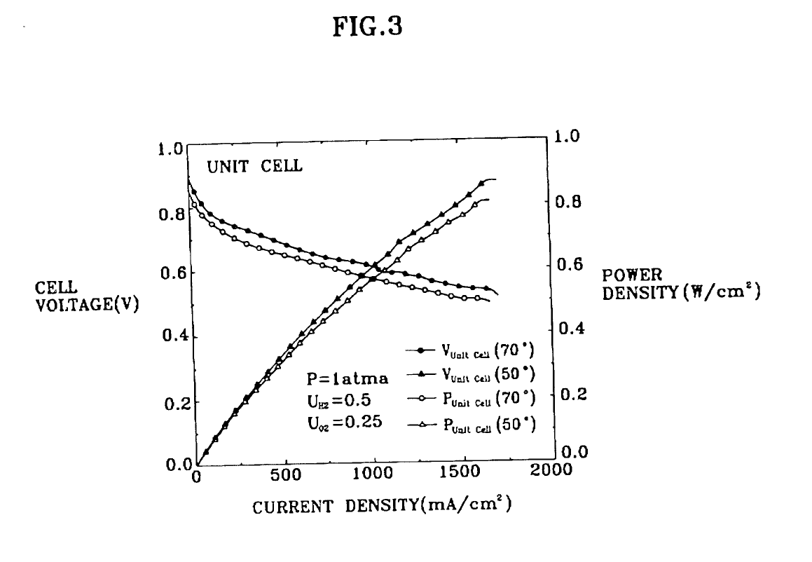

As shown in FIG. 3, although there is a certain degree of deviation in the current and voltage of each unit cell in a fuel cell under given operational conditions, the separate values demonstrate similar trends. Therefore, when information is processed in a monitoring system, a standard performance representing each unit cell as working normally may be determined and set up as a reference.

The operational domain of the unit cell thus described is usually in the 0.4V-OCV range (Open Circuit Voltage, usually 1.0V or so for a fuel cell) and anything outside this range is considered to be an abnormal operational domain. In other words, when the unit cell is working abnormally, it is common for the voltage to fluctuate irregularly out of the normal operation domain.

Unlike a secondary cell for storing electrical energy, a fuel cell energy converting device needs neither charging nor strict monitoring of the cell body such that it is sufficient to monitor only whether the voltage of the unit cell is maintained within a safe operation domain of the unit cell.

In the present invention, an A/D converter is not attached but two voltages (reference voltage and voltage of the unit cell) are directly compared on a circuit to monitor an operational state of the fuel cell.

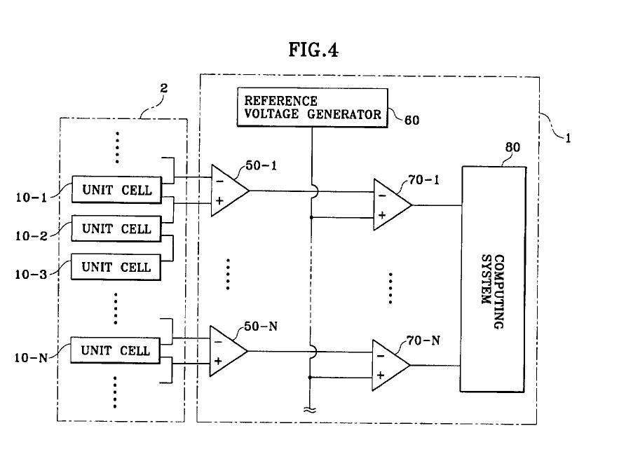

As shown in FIG. 4, a fuel cell monitoring system 1 according to the present invention includes a plurality of differential amplifiers (50-1˜50-N) connected to both ends of the unit cells (10-1˜10-N) to provide output voltages of each unit cell. Reference voltage generator 60 generates reference voltage. A plurality of comparators (70-1˜70-N) for compares the voltages of each unit cell output from the differential amplifiers (50-1˜50-N) with the reference voltage to output a digital signal of “0” or “1”. Computing system 80 receives the digital signal of “0” or “1” output from the comparators (70-1˜70-N) for processing in response to a previously-input program and to check whether each unit cell is working properly.

In an alternative embodiment, reference voltage generator 60 is not used. Instead, an average voltage, where the entire voltage of a cell system is divided by the number of unit cells or stacks, may be used as the reference voltage. In this embodiment, the comparators (70-1˜70-N) output “1” if the voltage of the unit cell is above the reference voltage and output “0” if the voltage of the unit cell is below the reference voltage. A circuit comprising the comparators (70-1˜70-N) may be constructed in the reverse, wherein the comparators output “0” if the voltage of the unit cell is below the reference voltage and output “1” if the voltage of the unit cell is above the reference voltage.

In the present invention thus constructed, normal or abnormal operation in the voltage of the unit cell comprising the fuel cell is simply set as “1” or “0” such that the amount of information necessary for processing information of each unit cell becomes only 1 bit. Furthermore, normal or abnormal signals of each unit cell are simultaneously processed in parallel, and also, abnormal signals of the unit cells are addressed in the computing system 80. In other words, it can easily be recognized at which unit cell the abnormalcy has occurred.

Each comparative circuit formed in as many numbers as the number of objects to be monitored, be constructed using an operating amplifier and can be easily embodied in an integrated circuit, to thereby increase information processing speed, simplify the monitoring system and greatly reduce the manufacturing cost.

As apparent from the foregoing, there is an advantage in the fuel cell monitoring system thus described according to the present invention in that various electronic elements such as A/D converters, relays and the like can be removed, and instead, operating amplifiers are utilized to simplify the monitoring circuit. There is another advantage in that such a simplified monitoring system requires less information to be processed due to the simplified signal process, resulting in a simplified engine control program. There is still another advantage in that various electrical elements can be greatly reduced in number and provided as integrated circuits, thereby reducing the manufacturing cost and weight due to reduced volume and smaller housing. There is still a further advantage in that the manufacturing cost can significantly be reduced to advance the technology and time of practical use of fuel cell vehicles, as the fuel cell monitoring system is one of the elements needed into be applied to environment-friendly fuel cell vehicles.

What is claimed is:

1. A fuel cell monitoring system, comprising:
at least one differential amplifier communicating with at least one unit cell of the fuel cell to generate an output voltage corresponding to said at least one unit cell; and
at least one comparator communicating with said at least one differential amplifier, wherein said at least one comparator compares said output voltage to a reference voltage and generates a digital signal based on said comparison, wherein said digital signal is adapted for monitoring the fuel cell.

2. The fuel cell monitoring system according to claim 3, further comprising a reference voltage generator communicating with said comparator.

3. The fuel cell monitoring system according to claim 4, wherein said comparator outputs a 1 or 0, said output dependent upon said comparison.

4. The fuel cell monitoring system according to claim 3, wherein said reference voltage comprises an average voltage computed by dividing a total cell system voltage by the number of unit cells.

5. The fuel cell monitoring system according to claim 6, wherein said comparator outputs a 1 or 0, one of said signals being output if the unit cell voltage is below the reference voltage and the opposite of said signals being output if the unit cell voltage is above the reference voltage.

6. The fuel cell monitoring system according to claim 3, wherein said fuel cell includes a plurality of unit cells and said monitoring system comprises one differential amplifier and one comparator corresponding to each said unit cell.

7. A monitoring system for a fuel cell, wherein the fuel cell comprises a plurality of unit cells, said monitoring system comprising:
a plurality of differential amplifiers, one corresponding to each said unit cell and being connected to both ends of a unit cell to generate an output voltage of the corresponding unit cell;
means for generating a reference voltage; and
a plurality of comparators, one corresponding to each differential amplifier, herein each said comparator compares said out put voltage to said reference voltage and generates a digital signal based on said comparison, said digital signal being adapted for monitoring the fuel cell the status.

8. The system according to claim 9, wherein said means for generating a reference voltage comprises a voltage generator.

9. The fuel cell monitoring system according to claim 10, wherein said comparator outputs a 1 or 0, said output dependent upon said comparison.

10. The system according to claim 9, wherein said means for generating a reference voltage comprises a processor programmed to compute an average voltage of said plurality of unit cells.

11. The fuel cell monitoring system according to claim 12, wherein said comparator outputs a 1 or 0, one of said signals being output if the unit cell voltage is below the reference voltage and the opposite of said signals being output if the unit cell voltage is above the reference voltage.
